(19) United States
(12) Patent Application Publication
(10) Pub. No.: US 2025/0039682 A1
(43) Pub. Date: Jan. 30, 2025

(54) REPORTING OF CLIENT DEVICE VIEW INFORMATION

(71) Applicant: HUAWEI TECHNOLOGIES CO., LTD., Shenzhen (CN)

(72) Inventor: Salah Eddine HAJRI, Shenzhen (CN)

(21) Appl. No.: 18/919,820

(22) Filed: Oct. 18, 2024

Related U.S. Application Data
(63) Continuation of application No. PCT/EP2022/060353, filed on Apr. 20, 2022.

(51) Int. Cl. H04W 16/18; H04L 5/00; H04W 16/28

(52) U.S. Cl. CPC H04W 16/18; H04L 5/0048; H04W 16/28

(57) ABSTRACT

The disclosure relates to the reporting of view information to provide an efficient tracking of a direction of view of a client device. The client device is configured to report view information to a network node. The view information indicates a relative angle of view of the client device and a detected or a predicted rotation of the client device. The received view information enables the network node to determine a view region for the client device which can be used to, e.g., schedule resources for the client device. Thereby, reducing resource utilization in a communication system while guaranteeing traffic requirements. The disclosure further relates to corresponding methods and a computer program.

### CROSS-REFERENCE TO RELATED APPLICATIONS

This application is a continuation of International Application No. PCT/EP2022/060353, filed on Apr. 20, 2022, the disclosure of which is hereby incorporated by reference in its entirety.

### TECHNICAL FIELD

The disclosure relates to a client device for reporting view information to a network node. The disclosure further relates to corresponding methods and a computer program.

### BACKGROUND

Extended reality (XR) is a term referring to all real-and-virtual combined environments and interaction between human and machine. XR englobes a wide array of use cases, including immersive game spectator, online XR gaming, augmented reality (AR), virtual reality (VR), mixed reality (MR), among others, and targets different domains such as healthcare, education, entertainment, education, marketing and advertising, etc.

XR use cases are expected to significantly impact 3GPP 5G new radio (NR) supported features and have some of the most demanding requirements. The requirements may be more or less critical for various use cases. For example, some XR use cases may rely on heavy uplink traffic, downlink traffic or both uplink and downlink traffic. Additionally, the requirement in terms of throughput varies considerably from use case to use case and depends on the architecture used for communication with a XR content server.

Two main architectures for XR content delivery can be considered, namely viewport-independent delivery and viewport-dependent delivery. The 3GPP definition for viewport applies in this context, i.e., a viewport is the part of the 3D content to render based on the pose and the field of view of the XR device.

In the viewport-independent delivery case, the entire XR scene is delivered and decoded, and pose information obtained from sensors is processed locally at the XR device. For the viewport-dependent delivery, the XR device delivers pose tracking information to the XR delivery engine to adapt the media request based on the pose information. This enables access at a given time only to data relevant to the current viewport. The viewport-dependent delivery can reduce the required bitrate by a factor of 2 to 4, for a given rendering quality, compared to viewport-independent delivery.

Additionally, some XR use case leverage interaction between extended reality and the user, based on user movements. Degrees of freedom (DoF) denote, in this context, the number of independent coefficients describing the movement of the user device viewport. Different types of DoFs are defined such as 3DoF, 3DoF+, 6DoF and constrained 6DoF.

XR pose generally defines a position and orientation in space with respect to an XR space. The position in the XR space can be defined as a 3D-vector representing the position within a space and relative to the origin. The orientation in XR space can be represented by a quaternion reflecting the orientation within a space and defined by a four-dimensional or homogeneous vector. Alternately, the information giving the coverage region of the view on a full sphere for a 360 video/content rendering can be based on center azimuth, center elevation, azimuth range, elevation range, and tilt angle. Other representations of the orientation are possible, e.g., by Euler angles.

5G NR was, until Release 17, primarily intended to support communication types such as e.g., enhanced mobile broadband (eMBB) and ultra-reliable low latency communication (URLLC). The requirements of XR traffic tend to share characteristics with both eMBB and URLLC communication types. This fact makes XR traffic particularly challenging, as the schemes used in 5G NR to address capacity, throughput, reliability, low latency requirements and power saving can be conflicting. For example, transmission repetition, used to improve coverage and reliability, can be conflicting with user equipment (UE) power savings, and capacity targets. So, enabling XR traffic is a matter of trade-offs between, at least, capacity, powers savings, latency and reliability.

### SUMMARY

An objective of embodiments of this disclosure is to provide a solution which mitigates or solves the drawbacks and problems of conventional solutions.

Another objective of embodiments of this disclosure is to improve XR traffic handling by providing an efficient and prompt view tracking for a client device running a XR service.

The above and further objectives are solved by the subject matter of the independent claims. Further embodiments of this disclosure can be found in the dependent claims.

According to a first aspect of this disclosure, the above mentioned and other objectives are achieved with a client device, the client device being configured to: receive reference signals from one or more network nodes; determine view information for the client device based on the received reference signals, the view information indicating a relative angle of view of the client device in relation to a reference direction, and a detected or a predicted rotation of the client device in relation to at least one rotational axis of the client device; and transmit a report message to a network node, the report message indicating the view information.

The reference direction may be defined in a reference plane which in turn may be defined in a given coordinate system. Hence, the reference direction may be considered as a reference vector in the reference plane.

An advantage with a client device according to the first aspect is that the network is provided with view information obtained at the client device. Based on the view information, the network can estimate a view region for the client device. The estimated view region may include view region margins and take into consideration client device mobility over time which enables the network to proactively adapting data transmissions based on the view region for the client device. Adapting data transmission may e.g., include resource allocation and link adaptation decisions.

In an embodiment of a client device according to the first aspect, the reference direction is a direction of a reception beam of the client device or a direction of a transmission beam of the client device.

An advantage with this embodiment is that the reference direction is known at both the client device and the network nodes, due to prior beam management procedures and channel state information (CSI) reporting, without requiring additional control signaling.

In an embodiment of a client device according to the first aspect, the relative angle of view is indicated based on the reception beam of the client device or the transmission beam of the client device.

An advantage with this embodiment is that the reference direction can be derived from the direction of the reception beam or transmission beam of the client device. As the beam management procedure enables to establish these beams, there will be no ambiguity between the client device and network with respect to the reference direction that the client device has used to compute the relative angle of view. Hence, this does not require additional signaling. Although the network does not know the explicit layout of cameras and antenna panels of the client device, the network would be able to derive an estimation of the direction in which the client device is pointing its visual sensors using knowledge of the directions of its own beams, uplink and downlink beam correspondence, and the network layout.

In an embodiment of a client device according to the first aspect, the relative angle of view is represented by an absolute angle value defining an angle between a direction of view of the client device and the reference direction.

An advantage with this embodiment is that a codebook containing different values for the relative angle of view can be specified in this respect. This enables to implement a low-overhead and simple reporting format solution.

In an embodiment of a client device according to the first aspect, the detected or predicted rotation of the client device comprises a yaw angle and a pitch angle of the client device.

An advantage with this embodiment is that rotation of the client device can be captured in a three-dimensional space. This will consequently enable to derive valuable insights on the variations of the view ports of the client device.

In an embodiment of a client device according to the first aspect, the yaw angle and the pitch angle are represented by at least one of: statistical angle values, angle values as a function of time, or measured angle values during a time period.

An advantage with this embodiment is that the variation of the client device orientation can be captured over extended time periods, in opposition to one snapshot of the client device orientation. This results in improved estimation of the view region at the network node.

In an embodiment of a client device according to the first aspect, the view information further indicates a region of translation for the client device.

An advantage with this embodiment is that the variations of the view region due to client device translation may be captured and considered by the network when estimating the view region for the client device. The client device translation may e.g., be defined along any of three spatial axes in a Cartesian coordinate system.

In an embodiment of a client device according to the first aspect, the region of translation for the client device is represented by one or more in a group comprising a set of transmission configuration indicator states, a set of reference signal resource indicators, a set of angles-of-arrival of a reception beam of the client device, and a set of angles-of-departure of a transmission beam of the client device.

An advantage with this embodiment is that already specified quantities or parameters can be used to convey the needed information about the client device translations, e.g., in a three-dimensional space, minimizing the required payload in control signaling to the network, such as uplink control information or uplink medium access control (MAC) control element (CE).

In an embodiment of a client device according to the first aspect, the client device is configured to: receive a configuration message from the network node, the configuration message indicating at least one of: a reporting format, a reporting type, and reporting resources; or transmit the report message based on the configuration message.

An advantage with this embodiment is that different reporting behaviors can be configured for the client device, namely, aperiodic, periodic, semi-persistent or event-triggered reporting behavior. Additionally, different reporting resources and formats can be configured according to this embodiment. Thus, the network is given multiple degrees of freedom to adapt view information reporting to ongoing traffic patterns in the communication system.

In an embodiment of a client device according to the first aspect, the client device is configured to: receive an assistance message from the network node, the assistance message indicating one or more in a group comprising the reference direction, an angle-of-arrival at the one or more network nodes of a reference signal resource transmitted by the client device, and angles-of-departure at the client device of the reference signals transmitted by the one or more network nodes; and determine the view information based on the received reference signals and the assistance message.

An advantage with this embodiment is that the quantities or parameters that the network communicates in the assistance message can help the client device to refine its view information estimations and combat the impact of non-line of sight communication which hinders the accuracy of view information estimation based on downlink reference signals.

According to a second aspect of this disclosure, the above mentioned and other objectives are achieved with a network node, the network node being configured to: receive a report message from a client device, the report message indicating view information for the client device, the view information indicating a relative angle of view of the client device in relation to a reference direction, and a detected or a predicted rotation of the client device in relation to at least one rotational axis of the client device; and determine a view region for the client device based on the report message.

An advantage of the network node according to the second aspect is that the network is provided with view information obtained at the client device. Based on the view information, the network can estimate a view region for the client device. The estimated view region may include view region margins and take into consideration client device mobility over time which enables the network to proactively adapting data transmissions based on the view region for the client device. Adapting data transmission may e.g., include resource allocation and link adaptation decisions.

In an embodiment of a network node according to the second aspect, the reference direction is a direction of a reception beam of the client device or a direction of a transmission beam of the client device.

An advantage with this embodiment is that the reference direction is known at both the client device and the network nodes, due to prior beam management procedures and CSI reporting, without requiring additional control signaling.

In an embodiment of a network node according to the second aspect, the relative angle of view is indicated based on the reception beam of the client device or the transmission beam of the client device.

An advantage with this embodiment is that the reference direction can be derived from the direction of the reception beam or transmission beam of the client device. As the beam management procedure enables to establish these beams, there will be no ambiguity between the client device and network with respect to the reference direction that the client device has used to compute the relative angle of view. Hence, this does not require additional signaling. Although the network does not know the explicit layout of cameras and antenna panels of the client device, the network would be able to derive an estimation of the direction in which the client device is pointing its visual sensors using knowledge of the directions of its own beams, uplink and downlink beam correspondence, and the network layout.

In an embodiment of a network node according to the second aspect, the relative angle of view is represented by an absolute angle value defining an angle between a direction of view of the client device and the reference direction.

An advantage with this embodiment is that a codebook containing different values for the relative angle of view can be specified in this respect. This enables to implement a low-overhead and simple reporting format solution.

In an embodiment of a network node according to the second aspect, the relative angle of view is represented by a shift in a transmission configuration indicator, an uplink reference resource indicator in relation to an uplink reference signal resource associated with the reference direction, or a shift in a downlink reference resource indicator in relation to a downlink reference signal resource associated with the reference direction.

An advantage with this embodiment is that the relative angle of view represented by a shift can be transmitted with a very low number of bits in uplink control signaling and the values for the relative angle of view would depend on the beam layout of the client device.

In an embodiment of a network node according to the second aspect, the detected or predicted rotation of the client device comprises a yaw angle and a pitch angle of the client device.

An advantage with this embodiment is that rotation of the client device can be captured in a three-dimensional space. This will consequently enable to derive valuable insights on the variations of the view ports of the client device.

In an embodiment of a network node according to the second aspect, the yaw angle and the pitch angle are represented by at least one of: statistical angle values, angle values as a function of time, or measured angle values during a time period.

An advantage with this embodiment is that the variation of the client device orientation can be captured over extended time periods, in opposition to one snapshot of the client device orientation. This results in improved estimation of the view region at the network node.

In an embodiment of a network node according to the second aspect, the view information further indicates a region of translation for the client device.

An advantage with this embodiment is that the variations of the view region due to client device translation may be captured and considered by the network when estimating the view region for the client device. The client device translation may e.g., be defined along any of three spatial axes in a Cartesian coordinate system.

In an embodiment of a network node according to the second aspect, the region of translation for the client device is represented by one or more in a group comprising a set of transmission configuration indicator states, a set of reference signal resource indicators, a set of angles-of-arrival of a reception beam of the client device, and a set of angles-of-departure of a transmission beam of the client device.

An advantage with this embodiment is that already specified quantities or parameters can be used to convey the needed information about the client device translations, e.g., in a three-dimensional space, minimizing the required payload in control signaling to the network, such as uplink control information or uplink MAC CE.

In an embodiment of a network node according to the second aspect, the network node is configured to transmit a configuration message to the client device for view information reporting, the configuration message indicating at least one of: a reporting format, a reporting type, or reporting resources.

An advantage with this embodiment is that different reporting behaviors can be configured for the client device, namely, aperiodic, periodic, semi-persistent or event-triggered reporting behavior. Additionally, different reporting resources and formats can be configured according to this embodiment. Thus, the network is given multiple degrees of freedom to adapt view information reporting to ongoing traffic patterns in the communication system.

In an embodiment of a network node according to the second aspect, the network node is configured to transmit an assistance message to the client device, the assistance message indicating one or more in a group comprising the reference direction, an angle-of-arrival at the one or more network nodes of a reference signal resource transmitted by the client device, and angles-of-departure at the client device of the reference signals transmitted by the one or more network nodes.

An advantage with this embodiment is that the quantities or parameters that the network communicates in the assistance message can help the client device to refine its view information estimations and combat the impact of non-line of sight communication which hinders the accuracy of view information estimation based on downlink reference signals.

According to a third aspect of this disclosure, the above mentioned and other objectives are achieved with a method for a client device, the method comprising: receiving reference signals from one or more network nodes; determining view information for the client device based on the received reference signals, the view information indicating a relative angle of view of the client device in relation to a reference direction, and a detected or a predicted rotation of the client device in relation to at least one rotational axis of the client device; and transmitting a report message to a network node, the report message indicating the view information.

The method according to the third aspect can be extended into embodiments corresponding to the embodiments of the client device according to the first aspect. Hence, an embodiment of the method comprises the feature(s) of the corresponding embodiment of the client device.

The advantages of the methods according to the third aspect are the same as those for the corresponding embodiments of the client device according to the first aspect.

According to a fourth aspect of this disclosure, the above mentioned and other objectives are achieved with a method for a network node, the method comprising: receiving a report message from a client device, the report message indicating view information for the client device, the view information indicating a relative angle of view of the client device in relation to a reference direction, and a detected or a predicted rotation of the client device in relation to at least one rotational axis of the client device; and determining a view region for the client device based on the report message.

The method according to the fourth aspect can be extended into embodiments corresponding to the embodiments of the network node according to the second aspect. Hence, an embodiment of the method comprises the feature(s) of the corresponding embodiment of the network node.

The advantages of the methods according to the fourth aspect are the same as those for the corresponding embodiments of the network node according to the second aspect.

Embodiments of this disclosure also relates to a computer program, characterized in program code, which when run by at least one processor causes the at least one processor to execute any method according to embodiments of this disclosure. Further, embodiments of this disclosure also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of this disclosure will be apparent from the following detailed description.

### BRIEF DESCRIPTION OF THE DRAWINGS

The appended drawings are intended to clarify and explain different embodiments of this disclosure.

FIG. 1 shows a client device according to an embodiment of this disclosure.

FIG. 2 shows a flow chart of a method for a client device according to an embodiment of this disclosure.

FIG. 3 shows a network node according to an embodiment of this disclosure.

FIG. 4 shows a flow chart of a method for a network node according to an embodiment of this disclosure.

FIG. 5 shows a communication system according to an embodiment of this disclosure.

FIG. 6 shows signaling of view information reporting according to an embodiment of this disclosure.

FIGS. 7a-b show direction of view changes due to client device rotation according to embodiments of this disclosure.

FIGS. 8a-b show direction of view changes due to client device translation according to embodiments of this disclosure.

FIG. 9 shows a region of translation according to an embodiment of this disclosure.

FIGS. 10a-b show view regions according to embodiments of this disclosure.

FIG. 11 shows signaling of periodic view information reporting according to an embodiment of this disclosure.

FIG. 12 show signaling for event-triggered view information reporting according to an embodiment of this disclosure.

### DETAILED DESCRIPTION

The 5G NR schemes used to address capacity, reliability, low latency requirements and power saving can be conflicting, making especially XR traffic challenging. The schemes in 5G NR were intended for URLLC or eMBB services and may fall short from achieving XR requirements. For example, schemes used to increase reliability typically lead to a capacity drop. In addition, increased throughput typically leads to increased energy consumption and makes it harder to reach demanding reliability targets. One can conclude that exchange of additional information within the radio access network (RAN) and with the XR application server would be beneficial to enable the timely adaptation of the network lower layers to the XR traffic requirements.

Embodiments of this disclosure therefore provides a way to leverage the already performed radio resource measurements (RRMs) to speed up pose and view tracking and to provide more accurate low-cost tracking. With embodiments of this disclosure view information reporting using lower layers signaling is enabled to guarantee low latency. Furthermore, predictive view information tracking is enabled, and the view information is defined so that more information is conveyed on the expected UE view region compared to existing pose information formats according to conventional solutions.

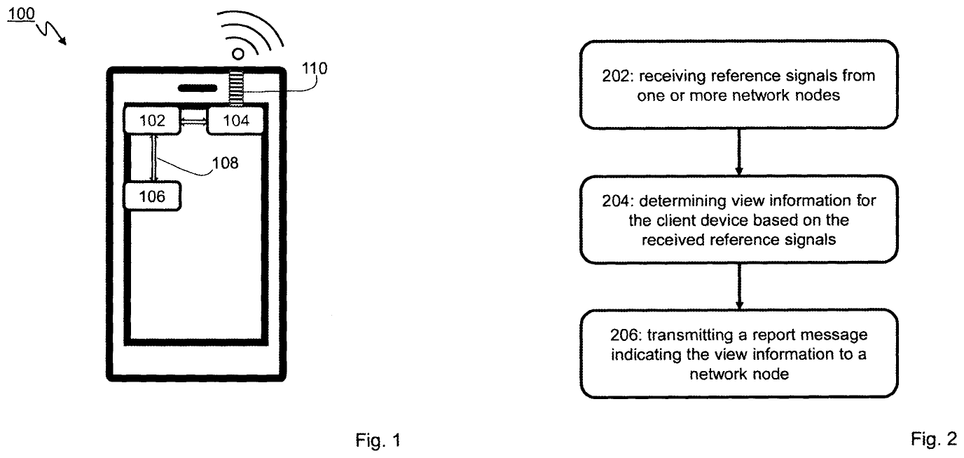

FIG. 1 shows a client device 100 according to an embodiment of this disclosure. In the embodiment shown in FIG. 1, the client device 100 comprises a processor 102, a transceiver 104 and a memory 106. The processor 102 is coupled to the transceiver 104 and the memory 106 by communication means 108 known in the art. The client device 100 further comprises an antenna or antenna array 110 coupled to the transceiver 104, which means that the client device 100 is configured for wireless communications in a communication system.

The processor 102 may be referred to as one or more general-purpose CPU, one or more digital signal processor (DSP), one or more application-specific integrated circuit (ASIC), one or more field programmable gate array (FPGA), one or more programmable logic device, one or more discrete gate, one or more transistor logic device, one or more discrete hardware component, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 104, memory 106 and/or processor 102 may be implemented in separate chipsets or may be implemented in a common chipset. That the client device 100 is configured to perform certain actions can in this disclosure be understood to mean that the client device 100 comprises suitable means, such as e.g., the processor 102 and the transceiver 104, configured to perform the actions.

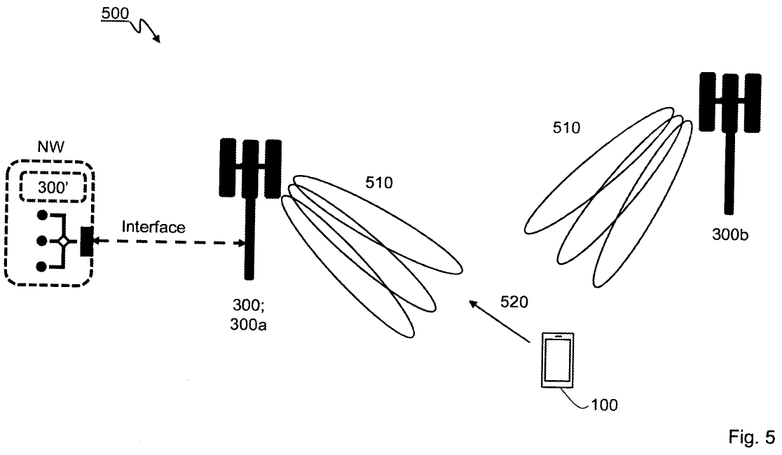

According to embodiments of this disclosure and with reference to FIGS. 1 and 5, the client device 100 is configured to receive reference signals 510 from one or more network nodes 300a, 300b, . . . , 300n and to determine view information for the client device 100 based on the received reference signals 510. The view information indicates a relative angle of view of the client device 100 in relation to a reference direction, and a detected or a predicted rotation of the client device 100 in relation to at least one rotational axis of the client device 100. The client device 100 is further configured to transmit a report message 520 to a network node 300, where the report message 520 indicates the view information.

FIG. 2 shows a flow chart of a corresponding method which may be executed in a client device 100, such as the one shown in FIG. 1. The method comprises receiving 202 reference signals 510 from one or more network nodes 300a, 300b, . . . , 300n and to determining 204 view information for the client device 100 based on the received reference signals 510. The view information indicates a relative angle of view of the client device 100 in relation to a reference direction, and a detected or a predicted rotation of the client device 100 in relation to at least one rotational axis of the client device 100. The method further comprises transmitting 206 a report message 520 to a network node 300, where the report message 520 indicates the view information.

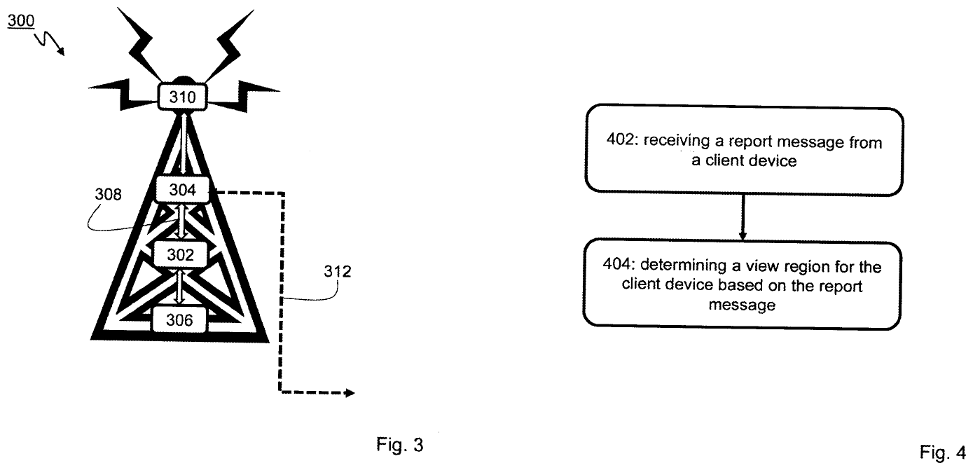

FIG. 3 shows a network node 300 according to an embodiment of this disclosure. In the embodiment shown in FIG. 3, the network node 300 comprises a processor 302, a transceiver 304 and a memory 306. The processor 302 is coupled to the transceiver 304 and the memory 306 by communication means 308 known in the art. The network node 300 may be configured for wireless and/or wired communications in a communication system. The wireless communication capability may be provided with an antenna or antenna array 310 coupled to the transceiver 304, while the wired communication capability may be provided with a wired communication interface 312 e.g., coupled to the transceiver 304.

The processor 302 may be referred to as one or more general-purpose CPU, one or more digital signal processor (DSP), one or more application-specific integrated circuit (ASIC), one or more field programmable gate array (FPGA), one or more programmable logic device, one or more discrete gate, one or more transistor logic device, one or more discrete hardware component, one or more chipset. The memory 306 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 304, the memory 306 and/or the processor 302 may be implemented in separate chipsets or may be implemented in a common chipset. That the network node 300 is configured to perform certain actions can in this disclosure be understood to mean that the network node 300 comprises suitable means, such as e.g., the processor 302 and the transceiver 304, configured to perform the actions.

According to embodiments of this disclosure and with reference to FIGS. 3 and 5, the network node 300 is configured to receive a report message 520 from a client device 100. The report message 520 indicates view information for the client device 100. The view information indicates a relative angle of view of the client device 100 in relation to a reference direction, and a detected or a predicted rotation of the client device 100 in relation to at least one rotational axis of the client device 100. The network node 300 is further configured to determine a view region for the client device 100 based on the report message 520.

FIG. 4 shows a flow chart of a corresponding method which may be executed in a network node 300, such as the one shown in FIG. 3. The method comprises receiving 402 a report message 520 from a client device 100. The report message 520 indicates view information for the client device 100. The view information indicates a relative angle of view of the client device 100 in relation to a reference direction, and a detected or a predicted rotation of the client device 100 in relation to at least one rotational axis of the client device 100. The method further comprises determining 404 a view region for the client device 100 based on the report message 520.

FIG. 5 shows a communication system 500 according to an embodiment of this disclosure. The communication system 500 in the disclosed example comprises a client device 100 and a first network node 300a and a second network node 300b configured to communicate and operate in the communication system 500. In the shown embodiment, the first network node 300a and a second network node 300b are network access nodes, such as e.g., gNBs, of a RAN. The first network node 300a is connected to a network (NW) such as e.g., a core network via a communication interface. Although not shown in FIG. 5, the second network node 300b is in a similar way connected to a network which may be the same or a different network than the shown network.

To improve the XR-specific handling of the client device 100, it would be beneficial to track the direction of view of the client device 100 in an efficient way. The direction of view can be defined as the direction in which the client device 100 is looking, e.g., a direction in which a camera or a sensor of the client device 100 is pointing. This information is unknown to the network, as the network does not know the layout of the client device 100, e.g., position of cameras with respect to antenna panels/beams.

According to embodiments of this disclosure conventional RRMs can be used to track the direction of view of the client device 100. In this way, the latency of the view tracking can be reduced and the accuracy increased. The present client device 100 is enabled to determine view information based on reference signals 510 received from one or more network nodes 300a, 300b, . . . , 300n. The view information is then reported to a network node 300, enabling the network node 300 to improve data transmissions for the client device 100.

In the embodiment shown FIG. 5, the client device 100 receives reference signals 510 from the first network node 300a and the second network node 300b, respectively. Based on the received reference signals 510, the client device 100 determines view information for the client device 100 and reports the view information to a network node 300 in a report message 520. In the shown embodiment, the network node 300 to which the view information is reported is the first network node 300a. Thus, the view information is in this case reported to a network access node but is not limited thereto. In embodiments, the view information may instead be reported to a network node 300′ e.g., located in the network, as indicated in FIG. 5. The network node 300′ may be any node/function in the network configured to receive and handle the view information, the network node 300 may e.g., be a location management function (LMF) of a core network. The view information comprises novel quantities which solely or in combination with other RRMs, can be used by the network node 300 to estimate a 3D region in which the direction of view of the client device 100 is expected to vary, as will be further described below.

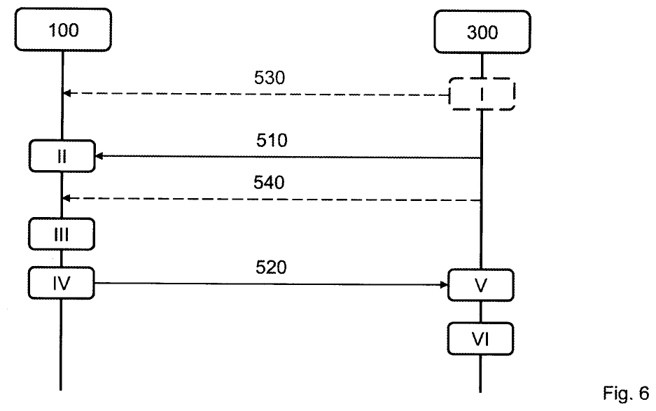

FIG. 6 shows signaling of view information reporting from a client device 100 to a network node 300 according to an embodiment of this disclosure.

In the optional operation I shown in FIG. 6, the network node 300 transmits a configuration message 530 to the client device 100 for view information reporting. The configuration message 530 indicates at least one of: a reporting format, a reporting type, or reporting resources. With the configuration message 530, the network node 300 may hence configure the reporting behavior of the client device 100, i.e., when and how the client device 100 reports the view information.

In operation II in FIG. 6, the client device 100 receives reference signals 510 from one or more network nodes 300a, 300b, . . . , 300n. In FIG. 6, the network node 300 is shown to send reference signals 510 to the client device 100. However, the client device 100 may receive reference signals 510 from one or more network nodes 300a, 300b, . . . , 300n which may or may not include the network node 300 to which the client device 100 reports the view information.

Based on the received reference signals 510, the client device 100 determines view information for the client device 100 in operation III in FIG. 6. The client device 100 may determine the view information based on a configuration, e.g., received in the configuration message 530. The view information may in embodiments be determined periodically, based on a trigger message from a network node 300 and/or based on an occurrence of an event meeting pre-specified or configured conditions which will be explained more in detail.

The determined view information indicates a relative angle of view of the client device 100 in relation to a reference direction and a detected or a predicted rotation of the client device 100 in relation to at least one rotational axis of the client device 100. The determined view information may further indicate a region of translation for the client device 100.

The relative angle of view may be seen as an estimation by the client device 100 of an angle between its direction of view and a reference direction. The direction of view of the client device 100 is the direction in which the client device 100 is “looking”, e.g., a direction in which a camera or a sensor of the client device 100 is pointing. The reference direction may be a direction of a reception beam BRX of the client device 100 or a direction of a transmission beam BTX of the client device 100. The relative angle of view may hence represent the angle between the direction of view of the client device 100 and a given beam. In this respect the relative angle of view may be indicated in a number of different ways and formats.

Hence, in embodiments, the relative angle of view may be indicated based on the reception beam BRX of the client device 100 or the transmission beam BTX of the client device 100. The relative angle of view may e.g., be indicated using an indication of a reference signal resource of the reception beam BRX or the transmission beam BTX, where angles-of-arrival or angles-of-departure of the reference signal resource is aligned with the relative angle of view. This would enable the network to derive the reference direction based on earlier performed operations for beam management and CSI reporting. From the network perspective, by knowing client device position, network layout and direction of departure of downlink reference signal resource or direction of arrival of uplink reference signal resource, the network can derive an estimation of reference direction of the client device 100 in a global coordinate system.

The relative angle of view may further be represented by an absolute angle value defining an angle between a direction of view of the client device 100 and the reference direction in a reference plane. The relative angle of view may be an angle value given in N number of coded bits. For example, a codebook of 2^{N} angle values can then be devised and used when reporting the view information.

The view information may indicate more than one relative angle of view of the client device 100. Hence, each relative angle of view may be associated with a respective panel of the client device 100 and/or a respective reference direction and/or reference plane. Thus, multiple relative angles of view may be indicated for multiple panels of the client device 100 and/or multiple reference directions and/or multiple reference planes. The reference directions may e.g., be associated with different network nodes 300a, 300b, . . . , 300n involved in transmission of reference signals. The more relative angles of view that are estimated and delivered to the network node 300, the better the accuracy of the estimated view region for the client device 100. In scenarios, such as multi-TRP and distributed antenna systems, the opportunity of averaging estimation errors across multiple network nodes is available and could be leveraged.

As aforementioned, the determined view information further indicates a detected or a predicted rotation of the client device 100 in relation to at least one rotational axis of the client device 100. In embodiments, the detected or predicted rotation of the client device 100 may comprise a yaw angle and a pitch angle of the client device 100.

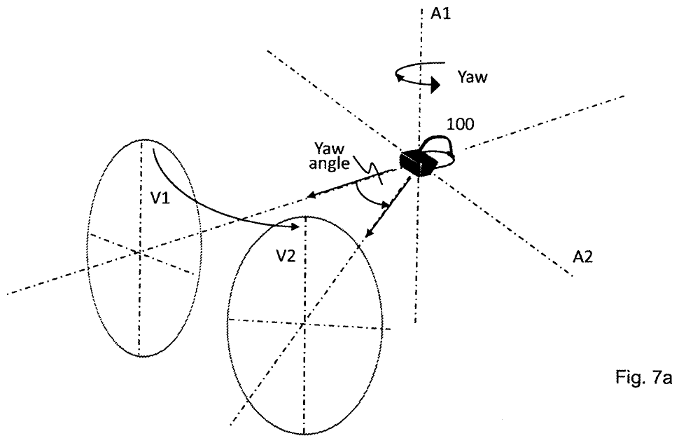

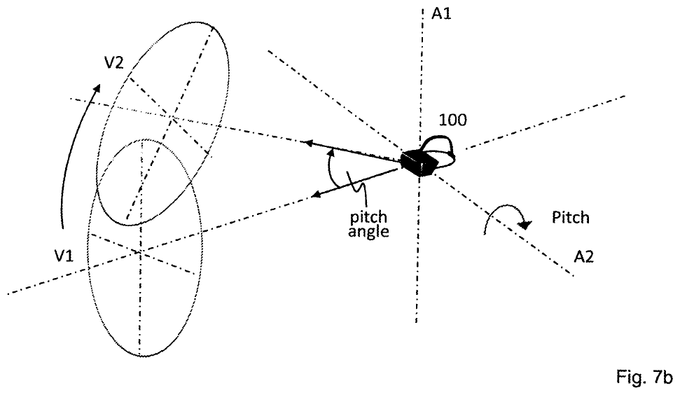

With reference to FIGS. 7a-b, yaw may be defined as a rotation around a vertical rotational axis A1 of the client device 100 and pitch may be defined as a rotation around a horizontal rotational axis A2 of the client device 100, respectively. Thus, the yaw angle may indicate a rotation around the vertical rotational axis A1 which changes the direction of view of client device 100 in the horizontal plane from a first direction of view V1 to a second direction of view V2, as indicated in FIG. 7a. The pitch angle may indicate a rotation around the horizontal rotational axis A2 which changes the direction of view of client device 100 in the vertical plane from a first direction of view V1 to a second direction of view V2, as shown in FIG. 7b. In other words, the yaw angle may represent a displacement of the direction of view from one side to another, while the pitch angle may represent a displacement of the direction of view either up or down.

Also, the yaw angle and the pitch angle may be represented in a number of different ways and formats. Thus, the yaw angle and the pitch angle may be given by at least one of: statistical angle values, angle values as a function of time, or measured angle values during a time period. Statistical angle values may be statistical quantities such as standard, mean, minimum, maximum and/or quantiles of the angle values. The client device 100 may obtain the statistical angle values by processing of reference signal measurement data associated with a time period. Regression models for machine learning may also be used and trained to predict a yaw angle and/or the pitch angle value over multiple time instances during a time period. Measured angle values during a time period may be obtained from unprocessed raw data of time series of measured angle values. By using statistical data, the accuracy of the estimated view region for the client device 100 can be improved.

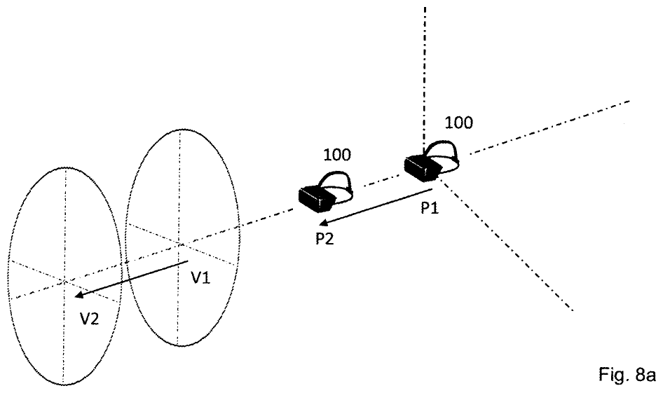

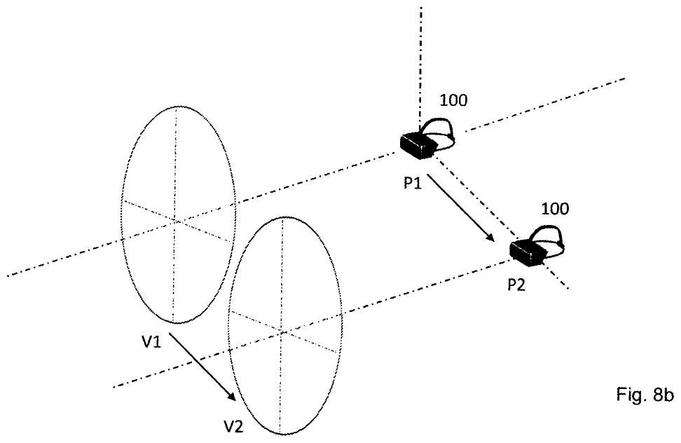

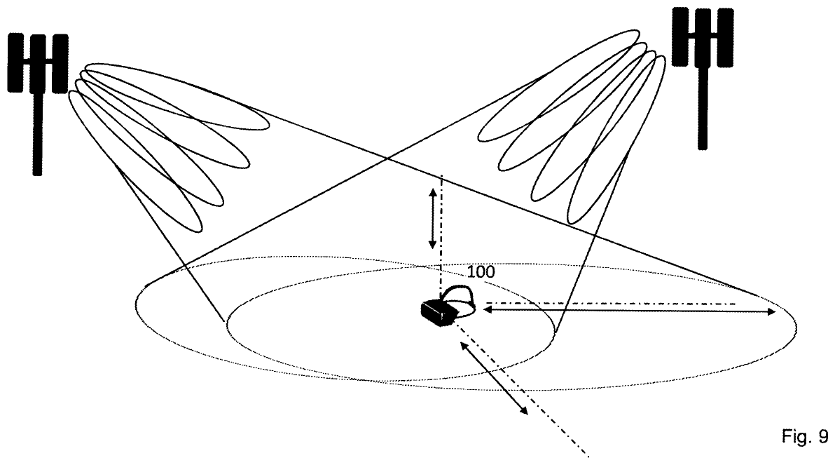

In embodiments, the view information may further indicate a region of translation for the client device 100 which also may impact the view region for the client device 100. The region of translation may indicate a region within which the client device 100 is expected to move and the corresponding effect on the view region from such client device translation. Examples of movements of the client device 100 and the change in view direction resulting from the movements are shown in FIGS. 8a-b. FIG. 8a shows a forward movement of the client device 100 from a first position P1 associated with a first direction of view V1 to a second position P2 associated with a second direction of view V2. FIG. 8b shows a sideway/lateral movement of the client device 100 from a first position P1 associated with a first direction of view V1 to a second position P2 associated with a second direction of view V2.

The region of translation for the client device 100 may be derived by the client device 100 from downlink reference signal measurements, as shown in FIG. 9. The region of translation for the client device 100 may be represented by one or more in a group comprising a set of transmission configuration indicator states, a set of reference signal resource indicators, a set of angles-of-arrival of a reception beam BRX of the client device 100, and a set of angles-of-departure of a transmission beam BTX of the client device 100. The set of transmission configuration indicator states and/or the set of reference signal resource indicators may be expected states and/or indicators, respectively. By knowing the coverage area of each downlink beam, the network can estimate a region in the three-dimensional space, in which the client device 100 is translating. Combined with other information at the network side, including the rest of view information quantities and bounds on the range or depth of the client device view, the network can derive a view region for the client device 100.

In embodiments, the client device 100 may determine the view information for the client device 100 further based on additional information from the network node 300. The client device 100 may receive the additional information in an assistance message 540 from the network node 300. Operation III in FIG. 6 may hence comprise the client device 100 determining the view information based on the received reference signals 510 and the assistance message 540. The information content of the assistance message 540 may therefore be an indication of an explicit reference direction, e.g., a last angle of view as estimated by the network, relative angles of departures or arrivals of reference signals from network nodes or at network nodes. The goal of the assistance information is to enable the client device 100 to derive better estimates of the view information as the impact of non-line of sight (NLS) propagation can prove detrimental.

The network node 300 may hence transmit an assistance message 540 to the client device 100, as indicated with a dashed arrow in FIG. 6. The assistance message 540 may indicate one or more in a group comprising the reference direction, an angle-of-arrival at the one or more network nodes 300a, 300b, . . . , 300n of a reference signal resource transmitted by the client device 100, and angles-of-departure at the client device 100 of the reference signals 510 transmitted by the one or more network nodes 300a, 300b, . . . , 300n.

The client device 100 receives the assistance message 540 from the network node 300 and determines the view information based on the received reference signals 510 and the assistance message 540. When determining the view information, the client device 100 may hence consider one or more of the information elements of the assistance message 540. For example, the reference direction in a reference plane may be used to derive the value of the relative angle of view. It is important to avoid any ambiguity about the reference direction, between the network and the client device 100. Indeed, the reference direction is critical in deriving the region of view in a global coordinate system. Further, the information regarding the angles of arrival and/or the angles of departure of reference signal resources can be used by the client device 100 to refine its estimation of the relative angle of view and the region of translation. Thus, the client device 100 may use the assistance information provided by the network in order to mitigate errors due to NLS propagation. Additionally, as estimation error may differ depending on which network node is transmitting or receiving reference signals, obtaining assistance information with respect to different network nodes enables to average out errors, or at least reduce the errors considerably.

In operation IV in FIG. 6, the client device 100 transmits a report message 520 to the network node 300, and the report message 520 indicates the view information determined in operation III in FIG. 6. The client device 100 may transmit the report message 520 to the network node 300 using lower layer signaling, such as layer 1 or 2 signaling or radio resource control (RRC) signaling. Hence, the report message 520 may e.g., comprise or be comprised in uplink control information (UCI), uplink (UL) MAC CE or a RRC message in a 5G NR context.

How and when the client device 100 transmits the report message 520 may in embodiments be determined by a reporting configuration received from the network node 300. As described with reference to the optional operation I in FIG. 6, the network node 300 may configure the client device 100 with the reporting configuration by transmitting a configuration message 530 to the client device 100. When the client device 100 receives such a configuration message 530 from the network node 300, the client device 100 obtains the reporting configuration indicated in the configuration message 530, i.e., at least one of: a reporting format, a reporting type, or reporting resources. The client device 100 then transmits the report message 520 based on the configuration message 530. Thus, the report message 520 transmitted in operation IV in FIG. 6 may e.g., be based on an indicated reporting format and/or the client device 100 may use indicated reporting resources to transmit the report message 520.

When it comes to reporting type or form, different alternatives can be configured by the network. The view information reporting may be periodic, aperiodic, semi-persistent or event-triggered. The reporting resources may e.g., point to specific PUCCH or PUSCH configured resources. The reporting format may define the format in which each of the view information quantities would be quantized. As different formats can be considered for each of the quantities, the network may choose one of the formats in the configuration, achieving a certain overhead accuracy trade-off.

In operation V in FIG. 6, the network node 300 receives the report message 520 from the client device 100. The network node 300 thereby obtains the view information for the client device 100 indicated in the report message 520.

In operation VI in FIG. 6, the network node 300 determines a view region for the client device 100 based on the received report message 520. The view region for the client device 100 can be understood to mean a 3D region in which the direction of view of the client device 100 is expected to vary due to mobility and orientation within a given time span. The view region may be determined in relation to the position of the client device 100. The position of the client device 100 may be determined in a conventional way using positioning schemes such as e.g., uplink and/or time difference of arrival (TDOA), positioning reference signal (PRS), sounding reference signal (SRS), downlink angles-of-departure, uplink angles-of-arrival, etc.

As described above, the view information indicates a relative angle of view of the client device 100 in relation to a reference direction, and a detected or a predicted rotation of the client device 100 in relation to at least one rotational axis of the client device 100. The view information may further indicate a region of translation for the client device 100. The network node 300 uses the indicated information to determine the view region for the client device 100. For example, from the relative angle of view, the network node 300 may identify the direction of view of the client device 100 and from the detected or predicted rotation, the network node 300 may identify the predicated or detected rotations of the direction of view of the client device 100, yaw and pitch-wise.

In embodiments, the relative angle of view may be represented by a shift in a transmission configuration indicator (TCI), an uplink reference resource indicator in relation to an uplink reference signal resource associated with the reference direction, or a shift in a downlink reference resource indicator in relation to a downlink reference signal resource associated with the reference direction. If a shift in TCI is used, the relative angle of view could represent the number of operations between the TCI associated with a beam direction that is aligned with the direction of view from the TCI associated beam that is aligned with the reference direction, e.g., by using an ordered list of TCIs. If a shift in reference signal resources is used, the relative angle of view could represent the number of operations between the reference signal resource transmitted using a beam that is aligned with the direction of view from the reference signal resource transmitted using the beam that is aligned with the reference direction, e.g., by using an ordered list of downlink reference signal resources.

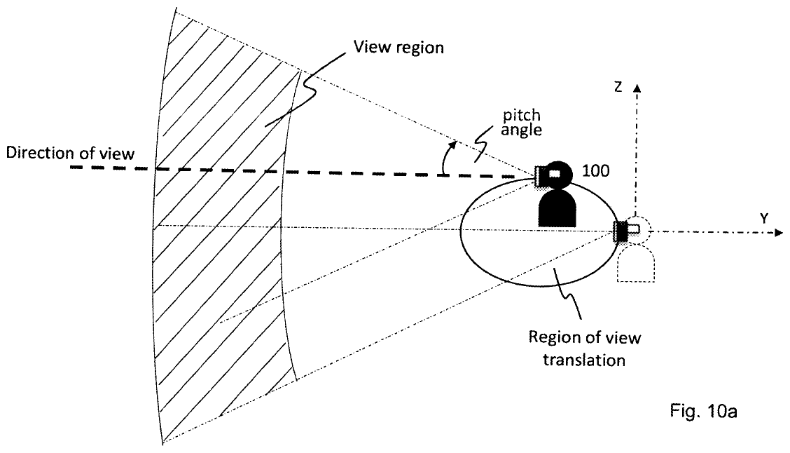

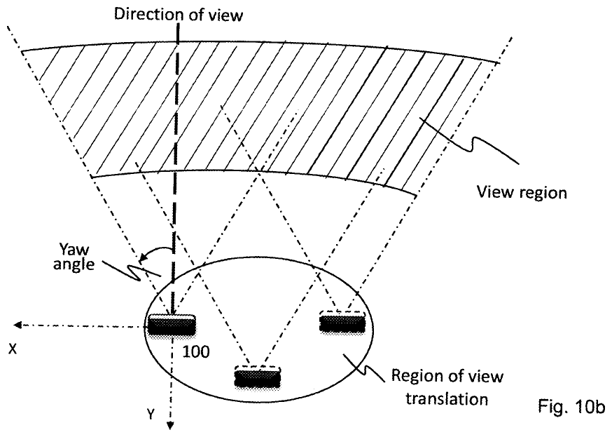

FIG. 10a-b show examples of view regions determined by the network node 300. FIG. 10a shows a current direction of view of the client device 100 and further indicates a pitch angle and a region of translation determined by the client device 100 and reported to the network node 300. The above-mentioned quantities are represented in the vertical plan. Based on the indicated pitch angle and region of translation for the client device 100, the network node 300 determines the view region shown from a sideview in FIG. 10a. FIG. 10b shows a current direction of view of the client device 100 and further indicates a yaw angle and a region of translation determined by the client device 100 and reported to the network node 300. The above-mentioned quantities are represented in the horizontal plan. Based on the indicated yaw angle and region of translation, the network node 300 determines the view region shown from a top view in FIG. 10b.

In embodiments, the network node 300 may be configured to schedule resources for the client device 100 based on the determined view region for the client device 100. In this way, the network node 300 may proactively adapt data transmission to movements and orientation of the client device 100 and thereby reduce resource utilization while guaranteeing traffic requirements. The determined view region for the client device 100 may e.g., enable the network to reduce the amount of data transmitted to the client device 100 at a given scheduling occasion. For example, the network node 300 can provision enough resources for data transmissions to the client device 100 covering its current view and margins within which the view is expected to evolve over a given time period. If the view of the client device 100 is changing rather slowly, significant saving may be achieved for traffic with high resource usage such a XR traffic.

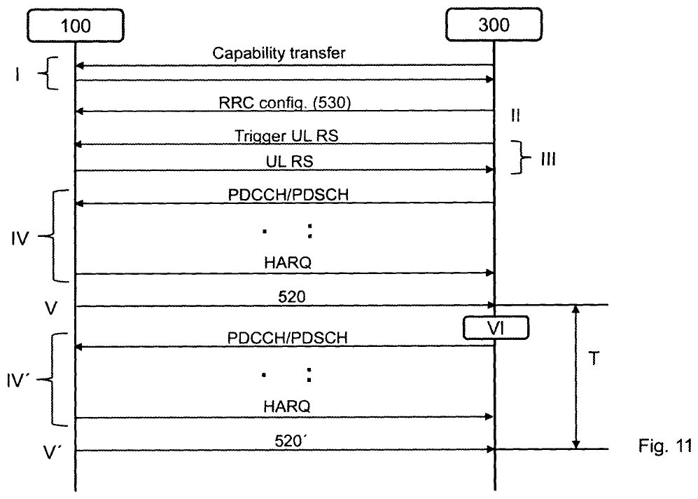

FIG. 11 shows an example of a general signaling diagram between a client device 100 and a network node 300 in a 3GPP 5G NR framework where the client device 100 is a UE and the network node 300 is a network access node, such as a gNB. The example in FIG. 11 illustrates periodic view information signaling according to an embodiment of this disclosure.

In operation I in FIG. 11, the UE 100 and the gNB 300 performs capability transfer to exchange capability information. The gNB 300 configures the UE 100 with a RRC configuration in a conventional way, in operation II in FIG. 11. The RRC configuration may additionally include a configuration message 530 relevant to view information reporting as previously described. In the shown embodiment, it is assumed that the UE 100 is configured by the gNB 300 to report the view information periodically with a reporting period T.

In operation Ill in FIG. 11, the gNB 300 triggers UL reference signal (RS) for the UE 100 and the UE 100 starts to transmit UL RS to the gNB 300.

In operation IV in FIG. 11, the UE 100 collects DL RS measurements, e.g., based on downlink reference signals in downlink channels such as physical downlink control channel (PDCCH) and/or physical downlink shared channel (PDSCH). Based on the collected DL RS measurements, the UE 100 determines view information. A general hybrid automatic request (HARQ) procedure may also be implemented together with the present view information reporting as also shown in FIG. 11.

The determined view information is transmitted to the gNB 300 in a report message 520 in operation V in FIG. 11.

Based on measurements of the UL RS transmitted by the UE 100 and the view information reported in the report message 520, the gNB 300 determines a view region for the UE 100 in operation VI in FIG. 11.

Since the UE 100 has been configured to report the view information periodically, operation IV and V is repeated such that another report message 520′ is transmitted to the gNB 300 during reporting period T, as shown in operation IV′ and V′ in FIG. 11.

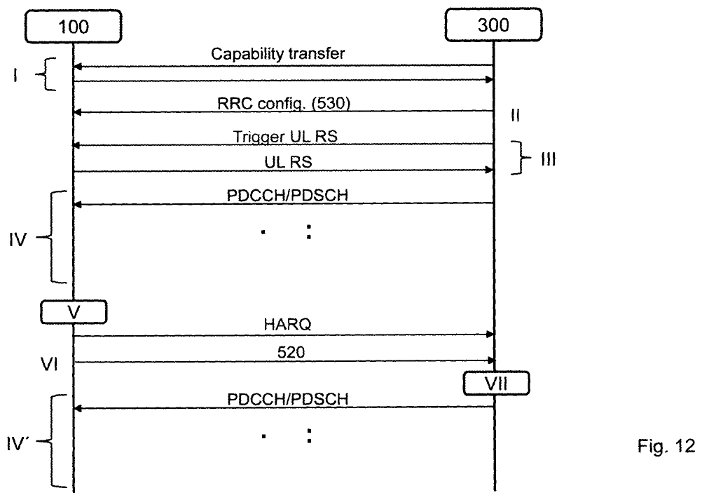

FIG. 12 compared to FIG. 11 on the other hand illustrates an event triggered signaling scheme of view information. Operations I to IV in FIG. 12 corresponds to operations I to IV in FIG. 11. However, in the example in FIG. 12, the UE 100 is instead configured to transmit the report message 520 based on one or more events, i.e., the reporting of view information is event-triggered. In one variant, the event may correspond to the rotational speed of the client device 100 exceeding a configured threshold value. In another variant, the event may correspond to the yaw and pitch angles variations exceeding configured threshold values. In yet another variant, the event may correspond to a UE translation exceeding a configured threshold value.

In operation V in FIG. 12, when the UE 100 detects an ongoing or upcoming event, i.e., an event fulfilling a configured view information reporting condition, the UE 100 transmits a report message 520 indicating the view information in operation VI in FIG. 12. Based on UL RS measurements and the view information reported by the UE 100 in the report message 520, the gNB 300 determines a view region for the UE 100 in operation VII in FIG. 12. The UE 100 continues to collect DL RS measurement for determining view information which is transmitted to the gNB 300 for each triggering event, as indicated with operation IV′ in FIG. 12.

The client device 100 herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station (STA), which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

The network node 300 herein may be a network access node or a network node. A network node herein may also be denoted as a core network node, a network function. In examples, view region computations may be performed at the location management function (LMF).

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access nodes may be of different classes or types such as e.g., macro eNodeB, home eNodeB or pico base station, based on transmission power and thereby the cell size. The radio network access node may further be a station (STA), which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

Furthermore, any method according to embodiments of this disclosure may be implemented in a computer program, having code means, which when run by processing means causes the processing means to execute the operations of the method. The computer program is included in a computer readable medium of a computer program product. The computer readable medium may comprise essentially any memory, such as previously mentioned a read-only memory (ROM), a programmable read-only memory (PROM), an erasable PROM (EPROM), a flash memory, an electrically erasable PROM (EEPROM), or a hard disk drive.

Moreover, it should be realized that the client device and the network access node comprise the communication capabilities in the form of e.g., functions, means, units, elements, etc., for performing or implementing embodiments of this disclosure. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Therefore, the processor(s) of the client device and the network access node may comprise, e.g., one or more instances of a central processing unit (CPU), a processing unit, a processing circuit, a processor, an application specific integrated circuit (ASIC), a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that this disclosure is not limited to the embodiments described above, but also relates to and incorporates all embodiments within the scope of the appended independent claims.

1. A client device for a communication system, the client device configured to:
receive reference signals from one or more network nodes;
determine view information for the client device based on the received reference signals, the view information indicating a relative angle of view of the client device in relation to a reference direction, and a detected or a predicted rotation of the client device in relation to at least one rotational axis of the client device; and
transmit a report message to a network node, the report message indicating the view information.

2. The client device according to claim 1, wherein the reference direction is a direction of a reception beam (B_{RX}) of the client device or a direction of a transmission beam (B_{TX}) of the client device.

3. The client device according to claim 2, wherein the relative angle of view is indicated based on the reception beam (B_{RX}) of the client device or the transmission beam (B_{TX}) of the client device.

4. The client device according to claim 1, wherein the relative angle of view is represented by an absolute angle value defining an angle between a direction of view of the client device and the reference direction.

5. The client device according to claim 1, wherein the detected or predicted rotation of the client device comprises a yaw angle and a pitch angle of the client device.

6. The client device according to claim 5, wherein the yaw angle and the pitch angle are represented by at least one of: statistical angle values, angle values as a function of time, or measured angle values during a time period.

7. The client device according to claim 1, wherein the view information further indicates a region of translation for the client device.

8. The client device according to claim 7, wherein the region of translation for the client device is represented by one or more in a group comprising a set of transmission configuration indicator states, a set of reference signal resource indicators, a set of angles-of-arrival of a reception beam (B_{RX}) of the client device, and a set of angles-of-departure of a transmission beam (B_{TX}) of the client device.

9. The client device according to claim 1, wherein the client device is configured to:
receive a configuration message from the network node, the configuration message indicating at least one of: a reporting format, a reporting type, or reporting resources; and
transmit the report message based on the configuration message.

10. The client device according to claim 1, wherein the client device is configured to:
receive an assistance message from the network node, the assistance message indicating one or more in a group comprising the reference direction, an angle-of-arrival at the one or more network nodes of a reference signal resource transmitted by the client device, and angles-of-departure at the client device of the reference signals transmitted by the one or more network nodes; and
determine the view information based on the received reference signals and the assistance message.

11. A network node for a communication system, the network node being configured to:
receive a report message from a client device, the report message indicating view information for the client device, the view information indicating a relative angle of view of the client device in relation to a reference direction, and a detected or a predicted rotation of the client device in relation to at least one rotational axis of the client device; and
determine a view region for the client device based on the report message.

12. The network node according to claim 11, wherein the reference direction is a direction of a reception beam (B_{RX}) of the client device or a direction of a transmission beam (B_{TX}) of the client device.

13. The network node according to claim 12, wherein the relative angle of view is indicated based on the reception beam (B_{RX}) of the client device or the transmission beam (B_{TX}) of the client device.

14. The network node according to claim 11, wherein the relative angle of view is represented by an absolute angle value defining an angle between a direction of view of the client device and the reference direction.

15. The network node according to claim 11, wherein the relative angle of view is represented by a shift in a transmission configuration indicator, an uplink reference resource indicator in relation to an uplink reference signal resource associated with the reference direction, or a shift in a downlink reference resource indicator in relation to a downlink reference signal resource associated with the reference direction.

16. The network node according to claim 11, wherein the detected or predicted rotation of the client device comprises a yaw angle and a pitch angle of the client device.

17. The network node according to claim 16, wherein the yaw angle and the pitch angle are represented by at least one of: statistical angle values, angle values as a function of time, or measured angle values during a time period.

18. The network node according to claim 11, wherein the view information further indicates a region of translation for the client device.

19. The network node according to claim 18, wherein the region of translation for the client device is represented by one or more in a group comprising a set of transmission configuration indicator states, a set of reference signal resource indicators, a set of angles-of-arrival of a reception beam (B_{RX}) of the client device, and a set of angles-of-departure of a transmission beam (B_{TX}) of the client device.

20. A method for a client device, the method comprising:
receiving reference signals from one or more network nodes;
determining view information for the client device based on the received reference signals, the view information indicating a relative angle of view of the client device in relation to a reference direction, and a detected or a predicted rotation of the client device in relation to at least one rotational axis of the client device; and
transmitting a report message to a network node, the report message indicating the view information.
